(19) United States
(12) Patent Application Publication
(10) Pub. No.: US 2017/0069346 A1
(43) Pub. Date: Mar. 9, 2017

(54) MAGNETIC DISK DEVICE, CONTROLLER AND DECODING METHOD

(71) Applicant: Kabushiki Kaisha Toshiba, Tokyo (JP)

(72) Inventors: Manabu Akamatsu, Kawasaki Kanagawa (JP); Akio Mizuno, Ome Tokyo (JP)

(21) Appl. No.: 15/049,399

(22) Filed: Feb. 22, 2016

Related U.S. Application Data
(60) Provisional application No. 62/215,448, filed on Sep. 8, 2015.

(51) Int. Cl. G11B 20/10; G11B 5/012

(52) U.S. Cl. CPC G11B 20/10009; G11B 5/012

(57) ABSTRACT

According to one embodiment, a magnetic disk device includes a disk, a head configured to write data to and read data from the disk, and a controller configured to compress data transmitted with a specific size into compressed data, add data of a first pattern to the compressed data to generate first data having the specific size, execute an encoding process to the generated first data, output second data obtained by encoding the first data, and execute a decoding process to the second data input from outside based on the first pattern.

### CROSS-REFERENCE TO RELATED APPLICATIONS

This application claims the benefit of U.S. Provisional Application No. 62/215,448, filed Sep. 8, 2015, the entire contents of which are incorporated herein by reference.

### FIELD

Embodiments described herein relate generally to a magnetic disk device, a controller and a decoding method.

### BACKGROUND

Recently, storage capacity of a hard disk drive (HDD), which is an example of a magnetic disk device, has been increased. In connection with the increase of the storage capacity, the storage density has been increased. In this situation, the HDD is required to correct errors with high quality. As one of the correcting techniques, for example, low-density parity-check (LDPC) encoding and decoding is known. An LDPC decoder using an LDPC code is employed in combination with a soft output Viterbi algorithm (SOVA) decoder. The HDD performing this error correction corrects error of a signal, using the likelihood of soft decision result output from the SOVA decoder. In this HDD, error rate can be improved by correcting the likelihood. By improving the error rate, storage capacity of the HDD will be further enhanced.

### BRIEF DESCRIPTION OF THE DRAWINGS

FIG. 1 is a block diagram showing configuration of a magnetic disk device according to an embodiment.

FIG. 2A is a block diagram showing an example of configuration of a read/write channel according to the embodiment.

FIG. 2B is a schematic diagram showing an example of state of data in a data write system.

FIG. 3 is a flowchart of a data write system of the read/write channel according to the embodiment.

FIG. 4 is a flowchart of a repetitive decoding process of the read/write channel according to the embodiment.

FIG. 5 is a flowchart of a repetitive decoding process of a read/write channel according to a modification example.

### DETAILED DESCRIPTION

In general, according to one embodiment, a magnetic disk device comprises: a disk; a head configured to write data to and read data from the disk; and a controller configured to compress data transmitted with a specific size into compressed data, add data of a first pattern to the compressed data to generate first data having the specific size, execute an encoding process to the generated first data, output second data obtained by encoding the first data, and execute a decoding process to the second data input from outside based on the first pattern.

### Embodiment

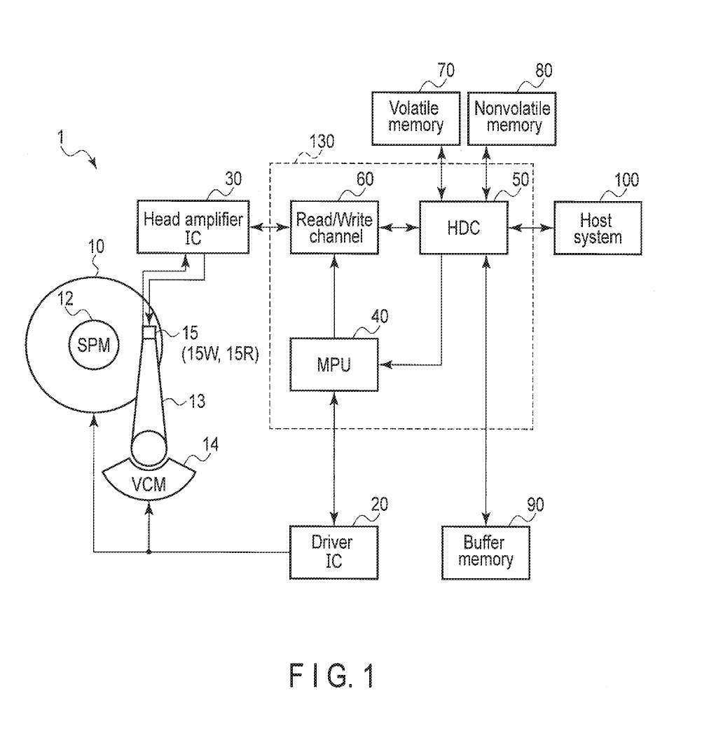

FIG. 1 is a block diagram showing the configuration of a magnetic disk device 1 according to an embodiment.

The magnetic disk device 1 comprises a head-disk assembly (HDA) as described later, a driver IC 20, a head amplifier integrated circuit (IC) 30, a volatile memory 70, a nonvolatile memory 80, a buffer memory (a buffer) 90 and a system controller 130 including a single-chip integrated circuit. The magnetic disk device 1 is connected with a host system (a host) 100.

The HDA comprises a magnetic disk (a disk) 10, a spindle motor (SPM) 12, an arm 13 comprising a head 15 and a voice coil motor (VON) 14. The disk 10 is rotated by the spindle motor 12. An actuator comprises the arm 13 and the VON 14. The actuator controls the head 15 provided in the arm 13 in order to move to a particular position on the disk 10 by driving the VCM 14. Two or more disks 10 and heads 15 may be provided.

The head 15 comprises a slider as the main body. The head 15 further comprises a write head 15W and a read head 15R provided in the slider. The read head 15R reads data recorded on the disk 10. The write head 15W writes data to the disk 10.

The driver IC 20 controls the driving of the SPM 12 and the VCM 14 in accordance with control of the system controller 130 (specifically, control of an MPU 40 as described later).

The head amplifier IC 30 comprises a read amplifier and a write driver. The read amplifier amplifies a read signal read by the read head 15R and transmits the amplified read signal to a read/write channel 60. The write driver transmits a write current to the write head 15W in accordance with the write data output from the read/write channel 60.

The volatile memory 70 is a semiconductor memory in which saved data is lost when power supply is stopped. The volatile memory 70 stores data necessary for process performed by each unit of the magnetic disk device 1. The nonvolatile 70 is, for example, a synchronous dynamic random access memory (SCRAM).

The nonvolatile memory 80 is a semiconductor memory which holds saved data even when power supply is stopped. The nonvolatile memory 80 is, for example, a flash read-only memory (flash ROM or FROM).

The buffer memory 90 is a semiconductor memory which temporarily stores, for example, data transmitted and received between the disk 10 and the host system 100. The buffer memory 90 may be provided integrally with the volatile memory 70. The buffer memory 90 is, for example, a dynamic random access memory (DRAM), an SDRAM, a ferroelectric random access memory (FeRAM) or a magnetoresistive random access memory (MRAM).

The system controller (the controller) 130 is realized by, for example, using a large-scale integration (LSI) called a system-on-a-chip (SoC), in which a plurality of elements are integrated into a single chip. The system controller 130 includes the microprocessor (MPU) 40, a hard disk controller (HDC) 50 and the read/write channel 60.

The MPU 40 is a main controller which controls the units of the magnetic disk device 1. For example, the MPU 40 controls the VCM 14 via the driver IC 20 and performs servo control for determining position of the head 15.

The HDC 50 controls data transmission between the host system 100 and the read/write channel 60 in accordance with an instruction from the MPU 40.

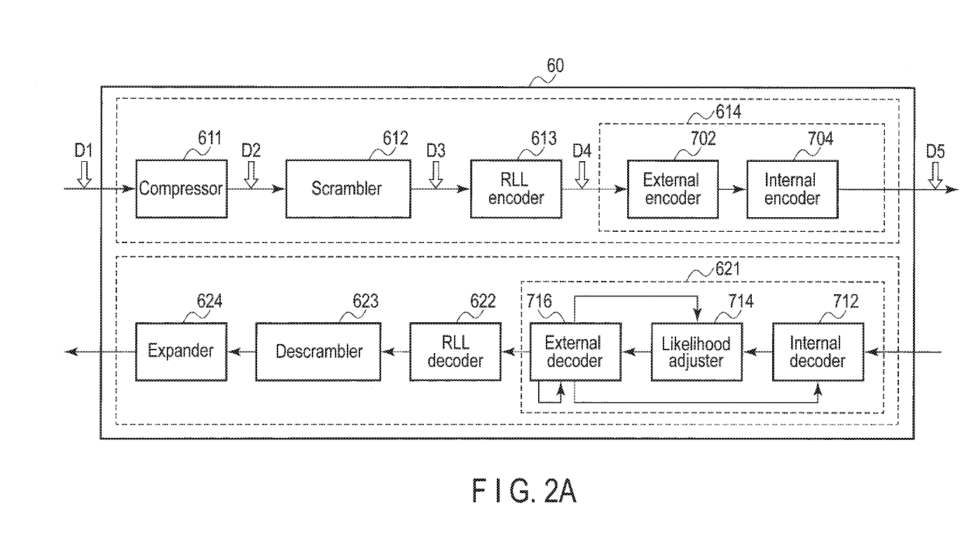

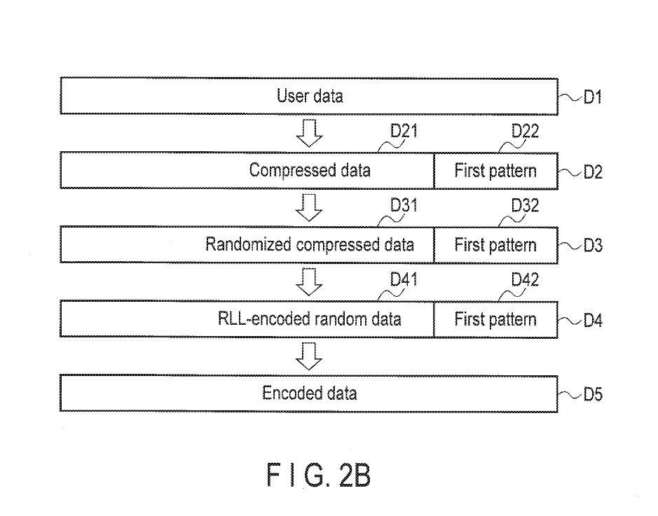

FIG. 2A is a block diagram showing an example of configuration of the read/write channel 60 according to the present embodiment. FIG. 2B is a schematic diagram showing an example of state of data in a data write system.

The read/write channel 60 performs signal process of read data and write data. The read/write channel 60 comprises a compressor 611, a scrambler 612, an RLL encoder 613, an encoder 614, a decoder 621, an RLL decoder 622, a descrambler 623 and an expander 624.

In a following description, a channel including the compressor 611, the scrambler 612, the RLL encoder 613 and the encoder 614 in series is called a data write system. A channel including the decoder 621, the RLL decoder 622, the descrambler 623 and the expander 624 in series is called a data read system.

Configuration of the data write system will be explained with reference to FIG. 2A and FIG. 2B.

The compressor 611 compresses user data (transmission data) D1 transmitted with a specific data size unit and generates compressed data D21 (see FIG. 2B). In the compressor 611, the compression rate differs depending on the type of transmission data (for example, moving image data, image data or audio data). The specific data size is, for example, the amount 10 which the unit is indicated by a symbol.

The compressor 611 generates known pattern (first pattern) D22 (see FIG. 2B). For example, the compressor 611 may obtain first pattern D22 stored in advance in the volatile memory 70 and the nonvolatile memory 80. For example, first pattern D22 is a pattern having a sequence of 0s and 1s.

The compressor 611 adds first pattern D22 to compressed data D21 in accordance with the data size which is reduced from the specific data size (in other words, in accordance with the reduced size or the reduced number of symbols) by compressing transmission data D1 having the specific data size. The compressor 611 may add first pattern D22 to the head of the data array of the compressed data or to the tail of the data array.

When the addition of first pattern D22 to compressed data D21 does not realize the attainment, of the specific data size, the compressor 611 further adds dummy data in order to attain the specific data size. Thus, the compressor 611 performs adjustment. In the following explanation, compressed data D21 and first pattern D22 may be collectively and simply referred to as compressed data D2 for the sake of convenience.

The compressor 611 outputs compressed data D2 having the specific data size. When transmission data cannot be compressed, the compressor 611 outputs the transmission data without compressing it.

The compressor 611 may hold the information of compressed data D21 and first pattern D22 (hereinafter, referred to as compression information) and supply (input) the information to each unit of the read/write channel 60. The information of compressed data D21 includes, for example, the compression rate of compressed data D21. The information of first pattern D22 includes, for example, the data size (the number of symbols) or the pattern array of first pattern D22 and the position of the addition of first pattern D22 to compressed data D21. When data cannot be compressed, the compressor 611 may hold information indicating that data cannot be compressed, and supply the information to each unit of the read/write channel 60. The compressor 611 may store compression Information as a table in a storage medium such as the volatile memory 70 or the nonvolatile memory 80.

The scrambler 612 executes a process for eliminating the regularity of the data array of the data input from the compressor 611, for example, compressed data D2 in short, a randomizing process). In other words, the scrambler 612 randomizes compressed data D21 and first pattern D22 included in compressed data D2. The scrambler 612 outputs randomized compressed data D3 (hereinafter, referred to as random data D3). Random data D3 includes randomized compressed data D31 and randomized first pattern D32. Hereinafter, randomized compressed data D31 included in random data D3 may be referred to as random data for the sake of convenience.

The run-length-limited (RLL) encoder 613 executes encoding (modulation) such that the number of successive 0s included in data is less than or equal to a particular number. The RLL encoder 613 applies an RLL encoding process to the data input from the scrambler 612, for example, random data D3. In other words, the RLL encoder 613 applies an RLL encoding process to random data D31 and first pattern D32 included in random data D3. In the following description, random data D41 which is obtained by the RLL encoding process and is included in RLL-encoded data D4 may be referred to as RLL-encoded data for the sake of convenience.

The encoder 614 executes a particular encoding process to the data input from the RLL encoder 613, for example, RLL-encoded data D4. The encoder 614 holds the information of first pattern D42 of RLL-encoded data D4 which has been supplied, and the information of encoded data D5 which has been output. The encoder 614 may supply the information of RLL-encoded data D4 and encoded data D5 to each unit of the read/write channel 60. The encoder 614 may store the information of RLL-encoded data D4 and encoded data D5 as a table in a storage medium such as the volatile memory 70 or the volatile memory 80.

The encoder 614 comprises an external encoder 702 and an internal encoder 704.

The external encoder 702 executes an external encoding process to RLL-encoded data D4 supplied from the RLL encoder 613. The external encoder 702 is, for example, a low-density parity-check code (LDPC) encoder. At this time, the external encoder 702 applies an LDPC encoding process to RLL-encoded data D4. The external encoder 702 applies an LDPC encoding process to RLL-encoded data D41 and first pattern D42 included in RLL-encoded data D4.

The internal encoder 704 executes an internal encoding process to the RLL-encoded data which is supplied from the external encoder 702 and is obtained by the external encoding process (hereinafter, referred to as external encoded data). The internal encoder 704 generates encoded data D5 by executing, for example, a partial response maximum likelihood (PRML) process to external encoded data. The internal encoder 704 outputs encoded data D5 which has been generated. Encoded data D5 includes RLL-encoded data D41 and first pattern D42 encoded by the encoder 614.

The write channel writes (specifically, the read/write channel 60 and the head amplifier IC 30 write) encoded data D5 output from the internal encoder 704 to the disk 10. Noise may be added to encoded data (write data) D5 written to the disk 10 at the time of writing and reading. As a result, an error may be generated in write data.

This specification explains the configuration of the data read system with reference to FIG. 2A.

The read channel reads (specifically, the read/write channel 60 and the head amplifier IC 30 read) write data (encoded data D5) from the disk 10.

The write data (encoded data D5) read from the disk 10 is supplied to the decoder 621. The decoder 621 applies a particular decoding process to encoded data D5. The decoder 621 comprises an internal decoder 712, an external decoder 716 and a likelihood adjuster 714.

The internal decoder 712 executes an internal decoding process to encoded data D5 and outputs the decoding result (decoded data) including likelihood information. The internal decoder 712 executes, for example, a decoding process coinciding to a PRML system to encoded data D5. The internal decoder 712 includes a soft output Viterbi algorithm (SOVA) decoder. At this time, likelihood information includes information related to the likelihood of the soft decision result output from the internal decoder 712. For example, as information related to the likelihood of the soft decision result, likelihood information includes the log-likelihood ratio (LLR) of encoded data D5 for each bit.

The likelihood adjuster 714 adjusts the likelihood based on the information of the first pattern and the information of a known pattern (a second pattern) included in the data obtained in the data read system. The likelihood adjuster 714 outputs likelihood information including the adjusted likelihood. When the information of the first pattern cannot be obtained, the likelihood adjuster 714 determines that the supplied data is not compressed, and outputs the data without adjusting the likelihood.

The likelihood adjuster 714 is capable of obtaining the information of the first pattern from various units of the data write system, for example, the compressor 611 and the encoder 614. The likelihood adjuster 714 may obtain the information of the first pattern from a storage medium such as the volatile memory 70 or the nonvolatile memory 80. The likelihood adjuster 714 obtains the information of the second pattern from the data input from the internal decoder 712 and the external decoder 716.

The likelihood adjuster 714 compares the information of the first pattern with the information of the second pattern. For example, the likelihood adjuster 714 compares the first pattern with the second pattern. When the first pattern coincides with the second pattern, the likelihood adjuster 714 increases the likelihood. When the first pattern does not coincide with the second pattern, the likelihood adjuster 714 decreases the likelihood. The likelihood adjuster 714 may partially compare the first pattern with the second pattern to determine the coincidence or noncoincidence of the patterns. The likelihood adjuster 714 outputs likelihood information in which the likelihood is adjusted.

The external decoder 716 executes external decoding to the data input from the likelihood adjuster 714, for example, encoded data D5 which has been internally decoded. The external decoder 716 is, for example, an LDPC decoder.

The external decoder 716 executes LDPC decoding to the data input from the likelihood adjuster 714. The external decoder 716 provides the likelihood adjuster 714 with feedback the LDPC-decoding result (in other words, LDPC data).

If the likelihood is adjusted by the likelihood adjuster 714, the decoder 716 executes an error correction process to the data input from the likelihood adjuster 714, using an LDPC code, based on the adjusted likelihood information.

The external decoder 716 provides the internal encoder 712 with feedback the data obtained by the error correction process. The decoding process which is repeatedly executed by the internal decoder 712, the likelihood adjuster 714, the external decoder 716, etc., is hereinafter referred to as a repetitive decoding process.

The external decoder 716 executes a repetitive decoding process until the likelihood is sufficiently increased (in other words, the error becomes smaller) or until the number of times of the repetitive process between the internal decoder 712 and the external decoder 716 has reached a particular number. The external decoder 716 is capable of performing a repetitive decoding process internally. The external decoder 716 outputs the result of the repetitive decoding process (in other words, the data obtained by the repetitive decoding process).

The RLL decoder 622 executes RLL decoding to the data input from the external decoder 716, for example, the result of the repetitive decoding process.

The descrambler 623 executes a demodulation process for reverting the randomized data in order to recover the data array prior to the data being randomized. The descrambler 623 demodulates the data input from the RLL decoder 622.

The expander 624 obtains compression information and extends the data input from the descrambler 623 based on the information of the compression rate of the data in the compressor 611. At this time, the expander 624 obtains extended data including user data (hereinafter, referred to as user data D1) equivalent to user data D1 and the second pattern. The expander 624 deletes the second pattern and outputs user data D1 as read data. When compression information cannot be obtained, the expander 624 determines that the supplied data is not compressed, and outputs the data without extending it.

(Operation of Read/Write Channel)

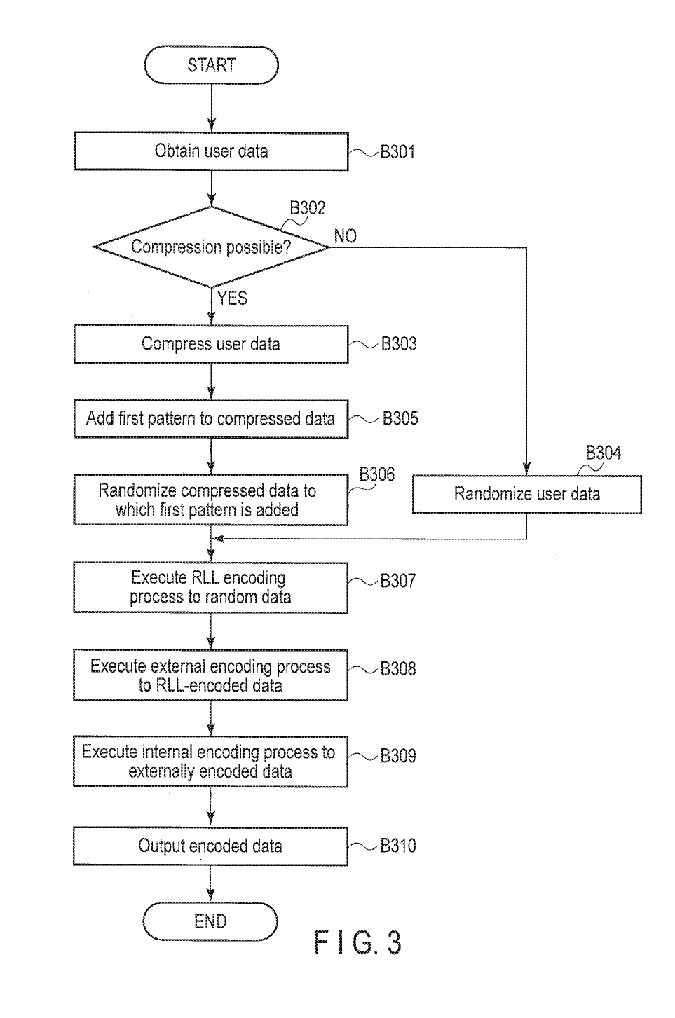

FIG. 3 is the flowchart of the data write system of the read/write channel 60 according to the present embodiment.

The read/write channel 60 obtains user data D1 from the HDC 50 (in block B301) and determines whether or not user data D1 can be compressed (in block B302).

When the read/write channel 60 determines that user data D1 can be compressed (YES in block B302), the read/write channel 60 compresses the user data with the compression rate in accordance with the type of user data D1 (in block B303). When the read/write channel 60 determines that user data D1 cannot be compressed (NO in block B302), the read/write channel 60 randomizes the user data (in block B304).

The read/write channel 60 adds first pattern D22 to compressed data D21 in the compressor 611 (in block B305), randomizes compressed data D2 to which first pattern D22 is added in the scrambler 612 (in block B306) and executes an RLL encoding process to random data D3 in the RLL encoder 613 (in block B307).

The read/write channel 60 executes an external encoding process to RLL-encoded data D4 in the external encoder 702 of the encoder 614 (in block B308). The read/write channel 60 uses an LDPC encoder as the external encoder 702 and executes an LDPC encoding process to RLL-encoded data D4.

The read/write channel 60 executes an internal encoding process to externally encoded data in the internal encoder 704 of the encoder 614 (in block B309). The read/write channel 60 executes a PRML process to externally encoded data as the internal encoding process.

The read/write channel 60 outputs encoded data D5 (in block B310).

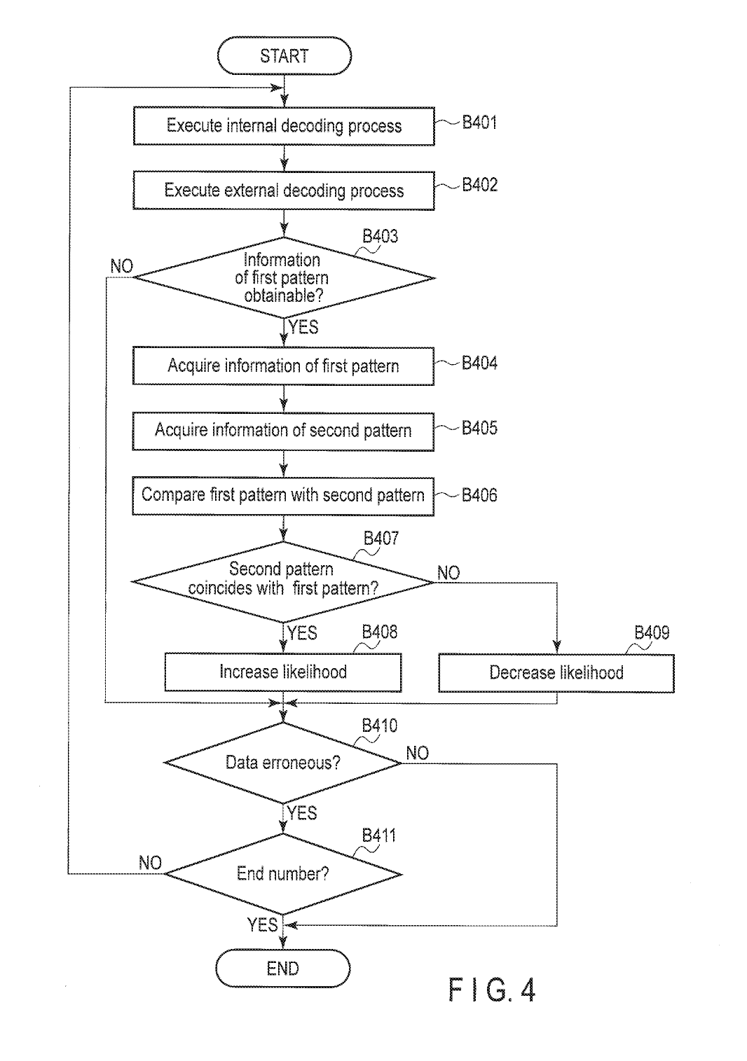

FIG. 4 is the flowchart of the repetitive decoding process of the read/write channel 60 according to the present embodiment. In the flowchart of FIG. 4, the read/write channel 60 shall obtain the encoded data processed in the flowchart shown in FIG. 3.

The read/write channel 60 executes an internal decoding process to the data (encoded data D5) supplied from the head amplifier IC 30 (in block B401). The read/write channel 60 executes a Viterbi decoding process to encoded data D5 with a SOVA decoder and outputs the decoding result including the likelihood information of the soft decision.

The read/write channel 60 executes an external decoding process to the data decoded by the internal decoding process (in block B402). The read/write channel 60 executes, as the external decoding process, an LDPC decoding process to encoded data D5 decoded by the internal decoding process.

The read/write channel 60 determines whether or not the information of the first pattern can be obtained (in block B403).

When the read/write channel 60 determines that the information of the first pattern cannot be obtained (NO in block B403), the read/write channel 60 proceeds to the process of block B410.

When the read/write channel 60 determines that the information of the first pattern can be obtained (YES in block B403), the read/write channel 60 obtains the information of the first pattern (an block B404).

The read/write channel 60 obtains the information of the second pattern from the data applied the external encoding process (in block B405).

The read/write channel 60 refers to the obtained information of the first pattern and the obtained information of the second pattern, compares the first pattern with the second pattern (in block B406) and determines whether or not the second pattern coincides with the first pattern (in block 6407).

When the read/write channel 60 determines that the second pattern coincides with the first pattern (YES in block B407), the read/write channel 60 increases the likelihood (in block B408). When the read/write channel 60 determines that the second pattern does not coincide with the first pattern (NO in block 6407), the read/write channel 60 decreases the likelihood (in block B409).

The read/write channel 60 determines whether or not the data applied repetitive decoding process has an error (in block B410).

When the read/write channel 60 determines that the data has an error (YES in block B410), the read/write channel 60 determines whether or not the number of times of the repetitive decoding process has reached the end number (in block B411).

When the read/write channel 60 determines that the data does not have an error (NO in block B410), the read/write channel 60 terminates the process.

When the read/write channel 60 determines that the number of times of the repetitive decoding process has reached the end number (YES in block B411), the read/write channel 60 terminates the process. When the read/write channel 60 determines that the number of times of the repetitive decoding process has not reached the end number (NO in block B411), the read/write channel 60 returns to the process of block B401.

in the present embodiment, the magnetic disk device 1 compresses transmission data transmitted with a specific data size unit and adds a known pattern having the data size of the released space to the compressed data. The magnetic disk device 1 encodes the compressed data including the known pattern and writes the data to the disk 10. The magnetic disk device 1 reads the encoded data including the known pattern from the disk 10 and performs a repetitive decoding process. The magnetic disk device 1 refers to the known pattern and corrects the likelihood at the time of the repetitive decoding process. As a result, the magnetic disk device 1 is able to reduce the error rate.

This specification explains a modification example of the magnetic disk device of the present embodiment. In the modification example, the elements identical to those of the above embodiment are denoted by the same reference numbers or symbols as the embodiment. Thus, the detailed explanation of the elements is omitted.

### MODIFICATION EXAMPLE

In the modification example, the likelihood adjuster 714 obtains the information of the second pattern from the likelihood information output from the internal decoder 712. For example, the likelihood adjuster 714 obtains the information of the second pattern from the LLR of the likelihood information and compares the information of the first pattern with the information of the second pattern. The likelihood adjuster 714 refers to the information of the first pattern and the information of the second pattern, determines whether or not the first pattern coincides with the second pattern, and adjusts the likelihood. In this case, the likelihood adjuster 714 outputs the data in which the likelihood is adjusted to the external decoder 716.

The external decoder 716 executes an external decoding process to the data which is supplied from the likelihood adjuster 714 and includes the adjusted likelihood.

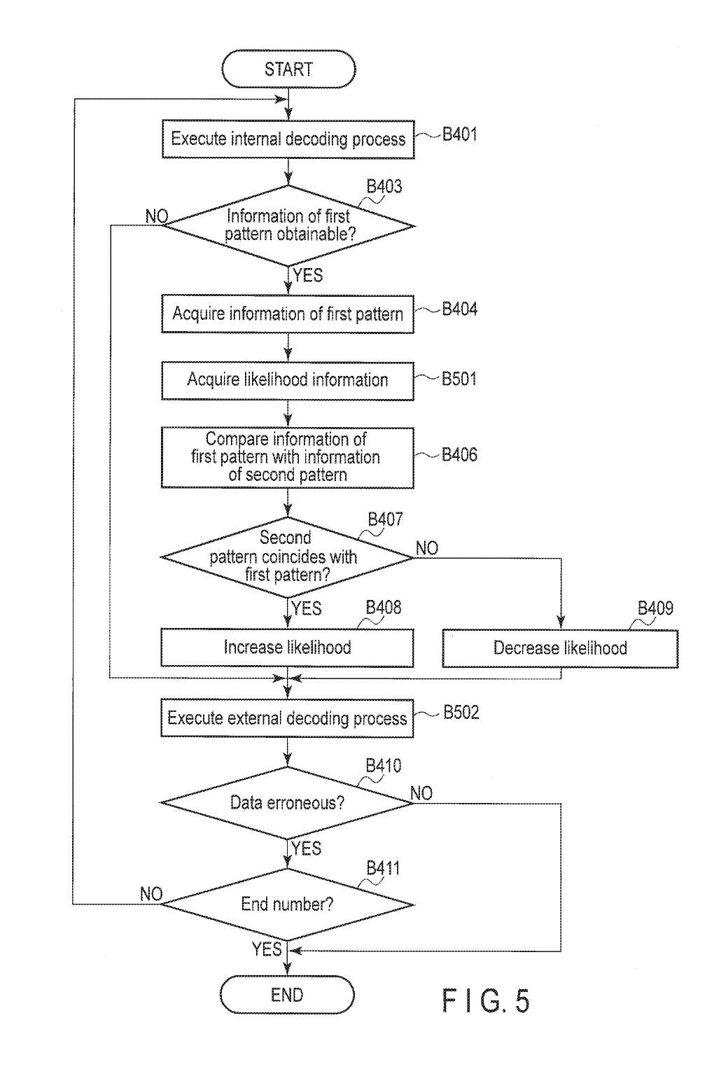

FIG. 5 is the flowchart of the repetitive decoding process of the read/write channel 60 according to the modification example. In the flowchart shown in FIG. 5, the processes equivalent to those of the flowchart shown in FIG. 4 are denoted by the same reference numbers or symbols as FIG. 4. Thus, the detailed explanation of the processes is omitted. In the flowchart shown in FIG. 5, the read/write channel 60 shall obtain the encoded data processed in the flowchart shown in FIG. 3.

After particular processing blocks, the read/write channel 60 obtains the likelihood information output from the internal decoder 712 (in block B501).

The read/write channel 60 performs the processes of blocks B406 to B409.

The read/write channel 60 executes an external decoding process to the data in which the likelihood is adjusted (in block B502).

The read/write channel 60 performs the processes of blocks B410 and B411 and terminates the whole process.

In the modification example, the magnetic disk device 1 is capable of adjusting the likelihood in the likelihood adjuster 714 without the intervention of the external decoder 716. As a result, the magnetic disk device 1 is capable of shortening the process in comparison with the above embodiment.

While a certain embodiment has been described, the embodiment has been presented by way of example only, and is not intended to limit the scope of the invention. Indeed, the novel embodiment described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the invention.

What is claimed is:

1. A magnetic disk device comprising:
a disk;
a head configured to write data to and read data from the disk; and
a controller configured to compress data transmitted with a specific size into compressed data, add data of a first pattern to the compressed data to generate first data having the specific size, execute an encoding process to the generated first data, output second data obtained by encoding the first data, and execute a decoding process to the second data input from outside based on the first pattern.

2. The magnetic disk device of claim 1, wherein
the controller holds, as information of the first pattern, the number of symbols of the first pattern added the compressed data and an data array of the first pattern.

3. The magnetic disk device of claim 2, wherein
the controller, in the decoding process, obtains likelihood information indicating a likelihood of the second data for each bit, refers to the held information of the first pattern to obtain a second pattern corresponding to the first pattern from third data obtained by decoding the second data, increases the likelihood when the first pattern coincides with the second pattern, and decreases the likelihood when the first pattern does not coincide with the second pattern.

4. The magnetic disk device of claim 1, wherein
the controller adds the data of the first pattern to a tail of the compressed data.

5. The magnetic disk device of claim 2, wherein
the controller executes an external encoding process and an internal encoding process to the second data in the encoding process, repeatedly executes an internal decoding process and an external decoding process in the decoding process, obtains likelihood information indicating a likelihood of the second data for each bit in the internal decoding process, refers to the information of the first pattern to obtain a second pattern corresponding to the first pattern from third data decoded by the internal decoding process, provides to the internal decoding process with feedback fourth data including a likelihood information in which the likelihood is increased when the first pattern coincides with the second pattern, and provides to the internal decoding process with, feedback fifth data including a likelihood information in which the likelihood is decreased when the first pattern does not coincide with the second pattern.

6. The magnetic disk device of claim 5, wherein
the internal decoding process comprises a decoding process using a soft output Viterbi algorithm, and the external decoding process comprises a decoding process using a low-density parity-check code.

7. The magnetic disk device of claim 1, wherein
the controller repeatedly executes the decoding process until an error is eliminated, and outputs sixth data obtained as a result of the decoding process.

8. A controller comprising:
a compressor configured to compress data transmitted with a specific size into compressed data, add data of a first pattern to the compressed data to generate first data having the specific size;
an encoder configured to execute an encoding process to the generated first data and outputs second data obtained by encoding the first data; and
a decoder configured to execute a decoding process to the second data input from outside based on the first pattern.

9. The controller of claim 8, wherein
the compressor holds, as information of the first pattern, the number of symbols of the first pattern added to the compressed data and a data array of the first pattern.

10. The controller of claim 9, wherein
the decoder, in the decoding process, obtains likelihood information indicating a likelihood of the second data for each bit, refers to the held information of the first pattern to obtain a second pattern corresponding to the first pattern from third data obtained by decoding the second data, increases the likelihood when the first pattern coincides with the second pattern, and decreases the likelihood when the first pattern does not coincide with the second pattern.

11. The controller of claim 8, wherein.
the compressor adds the data of The first pattern to a tail of the compressed data

12. The controller of claim 9, wherein
the encoder applies an external encoding process and an internal encoding process to the second data,
the decoder repeatedly executes an internal decoding process and an external decoding process in the decoding process, obtains likelihood information indicating a likelihood of the second data for each bit in the internal decoding process, refers to the information of the first pattern to obtain a second pattern, corresponding to the first pattern from third data decoded by the internal decoding process, provides to the internal decoding process with feedback fourth data including a likelihood information in which the likelihood is increased when the first pattern coincides with the second pattern, and provides to the internal decoding process with feedback fifth data including a likelihood information in which the likelihood is decreased when the first pattern does riot coincide with the second pattern.

13. The controller of claim 12, wherein
the internal decoding process comprises a decoding process using a soft output Viterbi algorithm; and
the external decoding process comprises a decoding process using a low-density parity-check code.

14. The controller of claim 8, wherein
the decoder repeatedly executes the decoding process until an error is eliminated, and outputs sixth data obtained as a result of the decoding process.

15. A decoding method applied to a magnetic disk device comprising a disk and a head which writes and reads data relative to the disk, the method comprising:
compressing data transmitted with a specific size into compressed data;
adding data of a first pattern to the compressed data to generate first data having the specific size;
executing an encoding process to the generated first data;
outputting second data obtained by encoding the first data; and
executing a decoding process to the second data input from outside based on the first pattern.

16. The decoding method of claim 15, further comprising
holding, as information of the first pattern, the number of symbols of the first pattern added to the compressed data and a data array of the first pattern.

17. The decoding method of claim 16, further comprising:
obtaining likelihood information indicating a likelihood of the second data for each bit in the decoding process;
referring to the held information of the first pattern to obtain a second pattern corresponding to the first pattern from third data obtained by decoding the second data;
increasing the likelihood when the first pattern coincides with the second pattern; and
decreasing the likelihood when the first pattern does not coincide with the second pattern.

18. The decoding method of claim 15, further comprising
adding the data of the first pattern to a tail of the compressed data.

19. The decoding method of claim 16, further comprising:
executing an external encoding process and an internal encoding process to the second data in the encoding process;
repeatedly executing an internal decoding process and an external decoding process in the decoding process;
obtaining likelihood information indicating a likelihood of the second data for each bit in the internal decoding process;
referring to the information of the first pattern to obtain a second pattern corresponding to the first pattern from third data decoded by the internal decoding process;
providing to the internal decoding process with feedback fourth data including a likelihood information in which the likelihood is increased when the first pattern coincides with the second pattern; and
providing to the internal decoding process with feedback fifth data including a likelihood information in which the likelihood is decreased when the first pattern does not coincide with the second pattern.

20. The decoding method of claim 19, wherein
the internal decoding process comprises a decoding process using a soft output Viterbi algorithm; and
the external decoding process comprises a decoding process using a low-density parity-check code.
